(19) United States
(12) Patent Application Publication
(10) Pub. No.: US 2016/0115715 A1
(43) Pub. Date: Apr. 28, 2016

(54) ANTITHEFT DEVICE FOR RETAIL ARTICLES

(71) Applicant: THOONSEN TRADING, Chateauroux (FR)

(72) Inventor: Jacky THOONSEN, Chateauroux (FR)

(73) Assignee: THOONSEN TRADING, Chateauroux (FR)

(21) Appl. No.: 14/757,501

(22) Filed: Dec. 23, 2015

Related U.S. Application Data
(62) Division of application No. 13/502,606, filed on Jun. 5, 2012.

(30) Foreign Application Priority Data
Oct. 19, 2009 (FR) 0957310

(51) Int. Cl. E05B 73/00

(52) U.S. Cl. CPC E05B 73/0017

(57) ABSTRACT

An antitheft device for off-the-shelf items includes a housing which contains an antitheft detection system and locking means hidden from view, and an attaching element that can be locked into the body of the housing. The device has in particular the appearance of a padlock. The attaching element forms the rigid loop of the padlock and is adapted to be placed in an attached position where it is held locked by one of its ends in the housing body.

### CROSS-REFERENCE TO RELATED APPLICATION

This application is a divisional application of U.S. patent application Ser. No. 13/502,606 filed on Jun. 5, 2012, which is a national stage application of International Patent Application No. PCT/FR2010/052199 filed on Oct. 15, 2010, and claims foreign priority to French Patent Application No. 0957310 filed on Oct. 19, 2009, the entire content of each of which is incorporated herein by reference.

### BACKGROUND OF THE INVENTION

This invention relates to a system that offers protection from theft, particularly shoplifting, in order to protect off-the-shelf items in a commercial retail establishment, particularly items of clothing such as garments, shoes and leather goods.

The antitheft devices known for such off-the-shelf items are most often of the type comprising a tag made up of two parts, one of which attaches to the item to protect and takes the form of a nail pierced through the item, and the other receives the point of the nail and contains the electronic antitheft system and a locking system that can hold captive the point of the nail.

For instance, patent application FR 2 395 553 describes such a device. The item to protect is thus pierced by the nail and held against the opposite part of the device, which retains the said nail. That same part comprises the electronic antitheft device such as a resonant electrical circuit with the capability to respond to the presence of a magnetic, radiofrequency or electromagnetic interrogation field of an outside detection system. When the item with an antitheft device goes through a surveillance or interrogation area, the electrical circuit of the antitheft device cooperates with the detection system put in place to trigger an alarm signal at the resonance frequency of the electrical circuit of the device.

The antitheft device is removed by means of a known magnetic support tool, on which the part of the device with the nail locking system is applied. The locking system of the device comprises a retaining part made of magnetic material that is adapted to be moved and associated with a spring. By positioning the tag bearing the locking system on the magnet, the creation of a magnetic field around the magnetic retaining part that is sensitive to the field leads to the said retaining part being attracted; the movement of the part releases the stem of the nail, which is then pushed back elastically by the spring. The nail is thus separated from the opposite part of the tag and can be removed from the item.

However, the drawback of such devices is that the item needs to be pierced, with the high risk of its being damaged, particularly if it is made of leather.

Further, the antitheft tag sometimes needs to be put together at a specific location, due to the type of the item and the need to pierce it. But the attachment point is not always convenient with some items, such as shoes, because that can particularly make them difficult to try on.

### SUMMARY OF SELECTED FEATURES

The invention removes the aforementioned drawbacks by offering an antitheft device that does away with the need to pierce the protected item, and is at the same time easy to attach to and take off the item.

According to the invention, the antitheft device for off-the-shelf items firstly comprises a housing, the body of which contains an antitheft detection system and locking means, and secondly an attaching element that can be locked into the body of the housing, particularly in the position where the device is attached to the article. The device is characterised in that the attaching element is filiform in shape and is attached to the housing so as to be mobile, the said element comprising a proximal end that is integral with the housing body and a distal end capable of being either in the attached position where it is held locked in the housing body (called the “device closed position”) or in the detached position where it is free and separate from the housing (called the “device open position”).

The attaching element is made of material that can only be cut with a tool, that is to say the attaching element is made of material that cannot be cut easily, or material that can only be cut with a tool such as pliers or a saw, and not a more common cutting tool such as scissors.

The device is particularly designed for certain types of item or item accessory that especially have a part forming a loop (such as a non-removable strap) or a hole that makes it possible to pass the attaching element via its movable end.

The attaching element is made of rigid material, such as metal. Rigid material means material that makes it impossible to tamper with the attaching element in the closed position when it is on an item to protect and in place in a store.

The filiform attaching element has straight and/or curved shapes. In the device closed position, the attaching element merely has to reproduce the shape of a line that is closed at its two ends, which line is closed on the item to protect.

The device according to the invention is thus used advantageously in the same way as a padlock, the housing body having a substantially parallelepiped shape, and the attaching element being shaped for example like an inverted U, the middle of the U forming a handle and the branches of the U forming two spaced stems respectively, one of which is permanently secured to the housing body while allowing at least some freedom of movement to the element, and the other is secured to the housing body in a way as to be detachable.

The handle of the attaching element allows the device to be hung from and held by a non-removable strap or a hole in an item that makes it possible to pass the attaching element through it.

Thus, the device allows for simple and fast attachment by passing the arch around the receiving part of the item.

The profile of the attaching element and the size of the device will be particularly adapted to the items to protect.

The detachable stem can only be removed from the housing after it has been secured to it with a specific and appropriate tool that makes it possible to move the stem out of the housing. The material or materials that make up the attaching element and the locking system internal to the housing thus make it impossible to separate the attaching element when it is secured to the housing.

The proximal end of the attaching element fixed to the housing is hooked and crimped, so that it can turn, on a fastening lug internal to the housing body and is encapsulated in the housing body. That fastening system, which is provided as an example, makes that end integral with the housing in a tamper-proof manner, while allowing it to move.

As a fastening alternative, the proximal end of the attaching element fixed to the housing is caught in a spring placed between two stops inside the housing, and is capable of turning and being displaced to fit and remove the distal end into and from the housing respectively.

According to one characteristic, the housing body comprises a cavity designed to receive the removable distal end of the attaching element, in which a locking part is able to move, preferably transversally to that end, so as to cooperate with it to lock it into place.

The removable distal end of the attaching element and the locking system particularly comprise retention means that cooperate with each other.

Advantageously, the removable distal end of the attaching element is pointed so as to make it easy to introduce into the housing.

The locking means that lock the removable distal end of the attaching element in place after it is inserted are placed in a part of the body that projects out from the rest of the body. That configuration facilitates cooperation by application against that projecting part of a suitable tool for unlocking without contact with the removable end of the attaching element.

Lastly, the antitheft detection system is an electronic theft detection system of the radiofrequency or magnetic-acoustic type.

### BRIEF DESCRIPTION OF THE DRAWINGS

The invention will be better understood in the light of the description below, which shows non-limitative examples of embodiment of the device of the invention, by reference to the accompanying drawings, wherein:

FIG. 1 is a perspective view of an antitheft device of the invention in the open position;

FIG. 2 represents a perspective view of the device in the closed position in an alternative housing form;

FIG. 3 is a sectional top view of the device of FIG. 2;

FIG. 4 is a sectional top view of the device of FIG. 2 in the open position;

FIGS. 5a to 5c are schematic top views of alternative forms of the attaching element of the device;

FIG. 6 is a perspective view of the device of FIG. 1 in the closed position and attached to a shoe to protect;

FIG. 7 shows the device of FIG. 5 in the open position thanks to cooperation with an appropriate unlocking tool;

FIG. 8 illustrates a top view of the inside of an additional alternative device.

### DETAILED DESCRIPTION

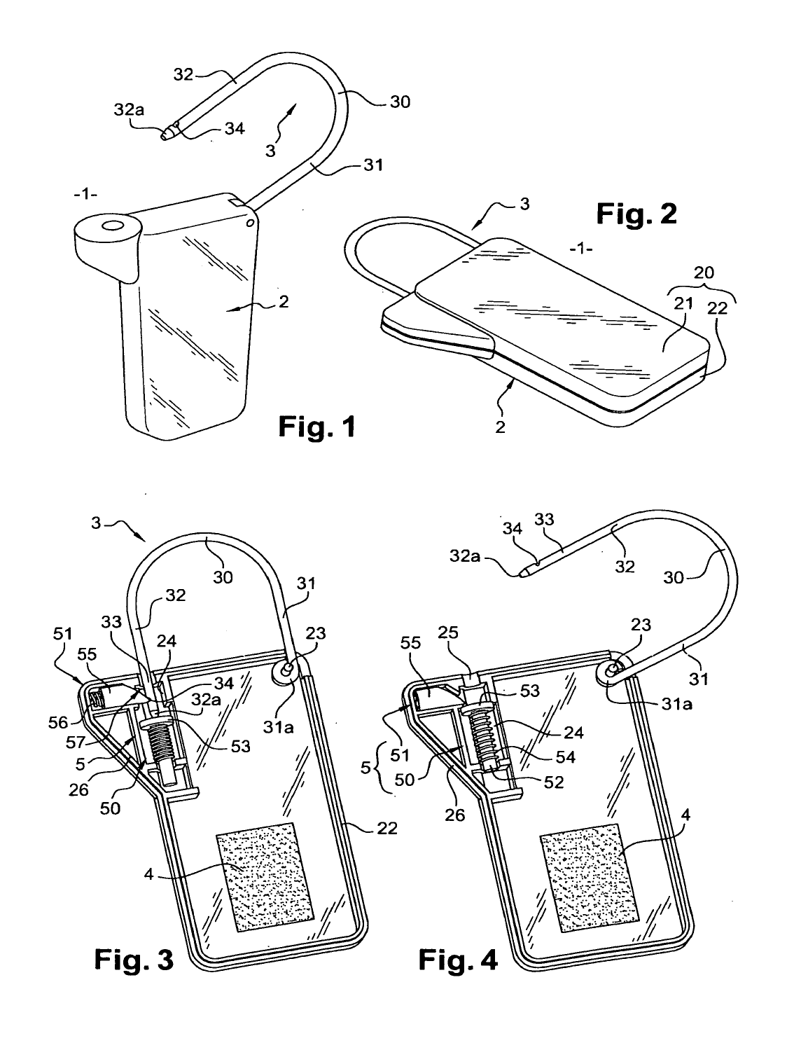

FIGS. 1 and 2 illustrate an antitheft device 1 according to the invention designed to be attached around non-removable straps or passed through holes of off-the-shelf items, for example garments, leather goods or sports goods, to protect them from shoplifting.

The device has the appearance of a padlock. It may be in the open position as shown in FIG. 1 or in the closed position as shown in FIG. 2, so as to be for example passed through an eyelet 7 of a lace-up shoe in the way shown in FIG. 6.

The device comprises a housing 2 and an attaching element 3 (also called “attachment” in the remainder of the description) designed to cooperate with the housing and be held locked there in the attached position. The attaching element 3, with an elongated and curved shape, like a loop, is designed to go round the strap of an item or be passed through the hole of an item.

In FIGS. 2 and 3, the housing 2 has a body 20, for example shaped substantially like a parallelepiped, which houses a theft detection system represented schematically by block 4, and locking means 5 that lock the attaching element 3 in the held position when it is inserted in the body of the housing 2.

The detection system 4 is a resonant electronic system of a known type, designed to cooperate with the detection and alarm emitter-receiver (not shown) outside the housing 2.

The locking means 5 will be detailed later.

The housing body 20 is preferably made of rigid plastic material such as polyvinylchloride (PVC).

The body 20 is preferably made up, as shown in FIG. 2, of two half shells 21 and 22 which are assembled to be non-removable from each other, after the electronic antitheft system 4 and the locking means 5 are placed inside (FIG. 3 or 4) and fixing one of the ends 31a of the attaching element 3.

The two half-shells are for example assembled by ultrasonic welding.

As an alternative, the body may take the form of a single piece moulded around the elements placed inside the housing.

By reference to FIGS. 2 and 3, the attaching element 3 has the shape of an arch or an inverted U and has a handle 30 (substantially semi-circular or semi-elliptical in shape) and two stems or branches 31 and 32 extending the handle on either side in parallel.

One of the stems 31 is integral with the housing body at its end 31 a opposite the handle 30.

While the attachment 3 is made of rigid material, it must be fastened to the body 2 so as to allow it at least one degree of freedom. In this case, in the example shown, the attachment 3 is shown articulated (at its proximal end 31a) on the housing 2 along the plane of the said housing.

The other stem 32 presents its distal end 32a opposite the handle, which is removable. It is either detached from the body of the housing (FIG. 1), the antitheft device being open and ready to be attached to an article, or secured to the body and locked there (FIGS. 2 and 6), the antitheft device being closed and locked and thus attached to an item (for example a shoe).

The stem 32 at the free end is preferably longer than the other stem, its end 32a and a portion 33 being intended to be inserted sufficiently into the housing to cooperate with the locking means 5.

The attaching element is made of material that cannot be cut using common means of cutting such as scissors. Indeed, it must not be possible to cut or break it either manually or with scissors, to thus prevent its detachment from the item to which it is attached in the store.

To that end, the material is preferably metal, in the form of a braided cable or in the form of a rigid filiform part. It may for example be made of metal, particularly steel treated so as to not corrode.

As an alternative, the material is made from rigid plastic material with fibre reinforcement.

At least the material of the portion 33 intended to be inserted in the housing is made of at least one magnetised material such as iron, so as to cooperate with the locking means that are magnetised as will be seen below.

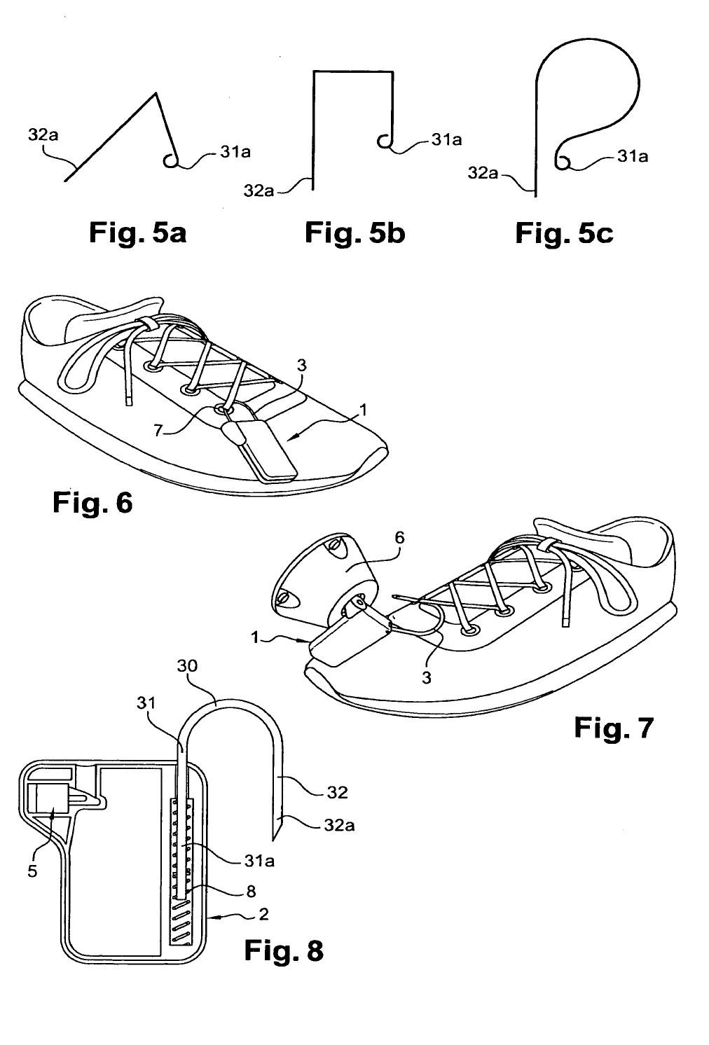

The attaching element 3 may take different forms, the different shapes of which are illustrated in FIGS. 5a to 5c. The line that makes up the attaching element located between the two ends 31a and 32a has straight and/or curved segments.

The ends 31a and 32a are separated by a distance so that with the device in closed position (FIGS. 2 and 3), the end 32a cooperates with the locking means 5.

By reference to FIGS. 3 and 4, the proximal end 31a is fixed to the housing body. It is made integral, so that it cannot break or be loosened if the stem 31 of the device is pulled. It may for example be fixed firmly by being shaped like a hook or hoop crimped around a pin 23 integral with the housing body. Further, the holding of that end 31a is reinforced by its being encapsulated between the two half shells of the housing body 20.

That end is rigid or may be flexible to allow it to move in relation to the housing for the insertion of the other end 32a in the housing. However, such flexibility requires the material to withstand breaking, so that the attachment is tamper-proof in the store.

When the attachment is made of rigid material, the fastening of the end 31 a is such that the attachment 30 can be made to move so as to allow the securing (removable) or the separation of the opposite end 32a in relation to the body 2.

The other distal end 32a is free and capable of being inserted in an appropriate cavity or recess 24 made in the housing body (FIGS. 3 and 4). The recess is oblong in shape so that in addition to the end 32a, an elongated portion of the end 33 of the stem can also be accommodated.

The edge of the housing body comprises a hole 25 for entry into the recess 24 for introducing the end 32a.

Advantageously, the hole 25 is shaped substantially like a funnel, whereas the end 32a is pointed so as to allow the end of the stem to the inserted by mutual guidance.

In the views in FIGS. 3 and 4, the locking means 5 that lock the portion 33 of the stem inside the housing can be seen. The locking means illustrated are provided as an example and are not limitative. Other locking means may be imagined.

These locking means 5 comprise a first supporting system 50 that is mobile by means of a spring and a second system 51 that is mobile by means of a magnetised spring to allow locking.

As shown in FIG. 4, the first supporting system 50 comprises a pin 52 fitted with a flat head 53 and a spring 54 placed around a pin. The pin is mounted to slide in the receiving recess 24 thanks to the spring between an upper and a lower stop.

By reference to FIG. 3, when the stem 32 is inserted in the housing, the end 32a is supported by the head 53 and pushes the pin 52 up to the lower stop, compressing the spring 54. At the same time, the locking system 51 is activated as will be shown below, to keep the stem 32 from being removed.

In the unlocking position of the second system 51, the spring 54 that was compressed expands, ejecting the stem 32 outside the housing.

The locking system 51 is transversal to the first system (FIGS. 3 and 4). It comprises a magnetised locking part 55 that is cylindrical in shape and a spring 56 that is supported between the edge of the housing and one of the ends of the locking part. The end of the magnet opposite the spring is intended to come out into the upper part of the recess 24.

When the portion 33 of the stem 32 is inserted in the recess 24, the magnetised locking part 55 is attracted to it as it is made of magnetic material. Advantageously, the locking part has a bevelled end 57 which cooperates with a notch 34 made in the portion 33 of the attaching element, thus making it impossible to remove the stem. Retaining and mutual cooperation means other than the illustrated elements 57 and 34 may be used.

Advantageously, the locking means that lock the removable distal end of the attaching element in place after it is inserted are placed in a part 26 of the body that projects out from the rest of the body. That arrangement makes it easier to apply against the housing an unlocking tool that is commonly used for usual antitheft tags, such as the tool 6 visible in FIG. 7, which has a cavity or recess into which the projecting part of the housing can be inserted.

The working of the antitheft device of the invention will now be described.

The antitheft device is in the open position for attachment to an item.

The handle 32 of the attaching element of the device is passed through a strap or, as in FIGS. 6 and 7, through the eyelet of a lace-up shoe.

The free stem 32 is inserted in the hole 25 of the housing and it is pushed into the housing till the locking system 5 is activated, the stem 32 being locked into position by the cooperation of the point 57 of the magnet in the notch 34 of the attaching element. The device is now closed and locked.

To take the device off the item, as shown in FIG. 7, a tool 6 that is adapted to the unlocking of the locking system is applied against the part of the body 26 of the housing accommodating the system 51. This is a powerful magnet that attracts the locking part 55 in a direction opposite the portion 33 in place in the recess 24. The movement of the locking part 55 uncouples it from the portion 33, and due to the action of the compression spring 54 of the supporting system 50, the stem 32 is ejected outside the housing. The device is now open once again.

The device of the invention is extremely easy to manoeuvre and handle by being simple to use, and avoids piercing the item to protect.

Other alternatives for fastening the attaching element 3 to the housing by its proximal end 31a are of course possible. FIG. 8 illustrates an additional example. The stem 31 at its proximal end 31a is caught in a spring 8, itself placed between two stops in a housing recess. In the device open position, the stem 31 is free to turn, making it easy to place the other end 32 around the product to protect. Once the rigid handle 30 is attached to the product, the user turns the stem 31 so as to place the end 32a of the other stem 32 opposite the cavity 24 of the housing. When the stem 31 attached to the spring 8 is pressed, the whole attaching element 3 is displaced, so that the end 32a is inserted in the cavity 24 in which the locking means 5 are activated.

What is claimed is:

1. A method of protecting an off-the-shelf item in a commercial retail establishment, the off-the-shelf item including a looping part or a hole, the method comprising:
inserting an attaching element of an antitheft device through the looping part or the hole of the off-the-shelf item, the attaching element being made of metal, filiform in shape, and attached to a housing of the antitheft device so as to be mobile, the attaching element comprising a proximal end that is rotatably fixed to a body of the housing and a distal end in a detached position in which the distal end is free and separate from the housing, the body of the housing containing an antitheft detection system and a locking unit;
turning the proximal end of the attaching element in relation to the body of the housing while the distal end is in the detached position;
locking the attaching element into the body of the housing of the antitheft device in an attached position in which the distal end is substantially immovably held locked in the body of the housing by the locking unit, thereby forming a handle that hangs directly from the off-the-shelf item to be protected.

2. The method according to claim 1, wherein a projecting part that projects from a side of the body of the housing houses a magnetized locking part and a first spring, the first spring being supported between an edge of the housing and one of ends of the magnetized locking part.

3. The method according to claim 2, comprising:
receiving the distal end of the attaching element in a cavity of the body of the housing, wherein the magnetized locking part of the locking unit is able to move in the cavity transversally to the distal end, so as to cooperate with the distal end to lock it into place.

4. The method according to claim 2, comprising:
catching the proximal end of the attaching element rotatably fixed to the body of the housing in a second spring placed between two stops inside the housing.

5. The method according to claim 2, comprising:
turning the proximal end of the attaching element;
displacing the proximal end of the attaching element to fit and remove the distal end into and from the housing respectively.

6. The method according to claim 1, comprising:
cooperating retention means of the locking unit and of the distal end of the attaching element with one another.

7. The method according to claim 1, wherein the distal end of the attaching element is pointed.

8. The method according to claim 1, wherein the antitheft detection system is a radiofrequency electronic theft detection system or a magnetic-acoustic electronic theft detection system.

9. The method according to claim 1, wherein the magnetized locking part includes a beveled end operable to engage a notch in the attaching element.

10. The method according to claim 1, wherein the proximal end of the attaching element fixed to the body of the housing is hooked and crimped, so that the attaching element can turn, on a fastening lug internal to the body of the housing and is encapsulated in the body of the housing.

11. The method according to claim 1, wherein the antitheft device has a generally rectangular shape.

12. The method according to claim 1, wherein the attaching element of the antitheft device includes a movable end, and the attaching element of the antitheft device is passed via its movable end through the looping part or the hole of the off-the-shelf item, the looping part including a non-removable strap of the off-the-shelf item, and the hole including an eyelet of a lace-up shoe.
